(19) United States
(12) Patent Application Publication
(10) Pub. No.: US 2025/0078784 A1
(43) Pub. Date: Mar. 6, 2025

(54) Banjo Mute And Damper

(71) Applicant: Cody Fielder Meyocks, Ashland, OR (US)

(72) Inventor: Cody Fielder Meyocks, Ashland, OR (US)

(21) Appl. No.: 18/458,064

(22) Filed: Aug. 29, 2023

(51) Int. Cl. G10D 3/046; G10D 1/10

(52) U.S. Cl. CPC G10D 3/046; G10D 1/10

(57) ABSTRACT

This banjo mute uses a unique design to expand and contract in order to fit between the coordinator rod or dowel stick of most banjos, and the underside of the banjo's head. It acts by applying varied pressure at different points along the underside of the banjo's head, thus effecting the volume, tone, and resonance of the instrument. It provides customizable volume adjustment and tonal control based on proximity to the bridge and amount of pressure applied. It could be used in a similar manner to effect the volume and tone of other stringed instruments.

### DESCRIPTION OF PRIOR ART

See: U.S. Pat. Nos. 1,708,169A, 1,819,339A, 1,810,259A, 611,183A, 754,059A, 774,750A, 1,332,552A, 1,800,588A, for patents where the application of material to the underside of the resonant surface of the banjo are the means for muting and/or damping sound.

### FIELD OF THE INVENTION

The invention is a height-adjustable banjo mute and damper, used to effect the volume and tone of a banjo or similar stringed instrument by applying pressure to the underside of the instrument's resonating surface or soundboard, thus reducing audible vibrations.

Fundamentally the job of the banjo, and other members the stringed instrument family, is to translate the vibration of strings to a resonant surface by way of a bridge, after which the resonant surface then amplifies and projects the vibration of the strings to make pleasant and audible sounds.

When a change in the volume or tone of the instrument is desired, the first place it may take place is at the strings themselves, then at the bridge, then at the resonant surface itself. The majority of currently manufactured banjo mutes seek to limit resonance at the bridge, typically by means of adding mass and thus limiting vibration at the bridge itself, as in U.S. Pat. Nos. 3,797,355A, 1,761,294A, 20,070,006711A1, 821,494A, 3,994,196A, 5,347,906A, etc. While very effective at restricting volume, this method typically allows for a simple on/off binary of application typically—either the banjo makes noise as normal or it doesn't. Various elaborate alternative mechanisms have been invented for muting the banjo as well.

In addition a challenge exists in developing an over-bridge banjo mute which can act effectively on compensated or curved banjo bridges. An adjustable mute which contacts the underside of the head and doesn't rely on adding mass to the bridge is of wider application than most over-bridge mutes which are designed solely for use on standard linear banjo bridges.

Furthermore, a common practice of banjoists is to stuff some kind of soft material between the dowel stick or coordinator rod and the underside of the banjo head, far enough away that the effect on volume is negligible but tone is improved. The practice of stuffing soft material between the dowel stick and the underside of the banjo head is called “damping.” It gives a pleasant, warmer tone to most banjos, and notably decreases note sustain and thus brash overtones, resulting in a pleasant tone which banjoists enjoy. Various materials have been used for the purpose of damping, such as foam, rags, socks, stuffed animals, towels, leather scraps, animal skins, wine corks, pieces of wood, bits of metal, etc.

Sometimes material such as duct tape or shellac are adhered to the underside of the banjo head to effect “damping” as well, and the thickness and density of different banjo head materials (of which several options exist) effects volume and tone in a notably different, but similar ways. These all have their own unique effect on the volume and tone of a banjo, but tend to be single-faceted elements of the banjo's fundamental constitution or else limited adaptations of specific and single application, such as a bundled cloth used for its particular damping effect.

The greatest obstacle to designing a successful banjo mute and damper which acts by applying pressure to the underside of the head, and uses the banjo's dowel stick or coordinator rod for support, is the wide range of adjustability needed to accommodate the various distances between these two parts on various banjos. The distance between the coordinator rod or dowel stick and the underside of the banjo head ranges from as little as half an inch to as much as three inches, with outliers of those measurements being very uncommon. Some banjos lack a dowel stick or coordinator rod altogether.

The need to adjust the height of such a device is necessary even on a single banjo, as the distance to the underside of the head varies along the length of the dowel stick or coordinator rod, which are usually angled through the body or “pot” of the banjo. Furthermore the bridge has an effect as it depresses the banjo's resonant surface (its drum head) under string tension.

This requirement for adjustability invokes the need of some variety of a spring or screw to adjust the height of the muting surface-whereas a screw is superior because it affords a customizable amount of pressure applied to the head. Designing an expandable device within the range of motion and specific measurements necessary to be useful to a majority of banjos has proved difficult.

Some solutions in the past for similar, height-adjustable, under-head mutes or dampers, which use the dowel stick or coordinator rod for support, have included a bar of metal supported by a single spring in the center, a wooden platform pressed against the underside of the head by adjusting two wooden screws on either side of the dowel stick or coordinator rod, and the use of two opposite-facing acute triangles connected by a wire in such a way that they may slide apart and increase their height and thus press against the underside of the head the further they're separated.

### SUMMARY OF THE INVENTION

The current banjo mute and banjo tone damper is an adjustable device which can give a customizable spectrum of volume and tone options to its user. It does so by using a special and arduously devised blend of components that fit within a narrow range of measurement required to make it useful on a majority of banjo family instruments. It has the benefit of being able to apply a range of muting materials, which operate by contacting the underside of the banjo head. These materials include but are not limited to: leather, brass, wood, or wool, animal hide, etc. all of which have a distinct effect on the tone and volume of the instrument.

The mechanism of adjustability is a base component housing in its center an internal machine screw, which in turn is mated with an upper component consisting of a threaded post which both houses the screw and nests within the central opening in the base component. The threaded post is attached to an upper platform which applies pressure to the underside of the banjo head and performs the act of limiting vibration. A spring housed in a non-threaded post could feasibly be substituted as a mechanism of adjustment, and is included to allow for the possibility of that alternative design.

The degree in which vibrations in the resonant surface of the banjo head are limited by the device is highly variable and provides a wide spectrum of customizable effects for tone and volume, based mainly on the blending of these components: (1) the damping material used to contact the head (2) the damping surface's proximity to the instrument's bridge, and (3) the amount of pressure applied through the adjustment of the mechanism's height. The harder the damping material is, the more it will retain clarity of tone whereas softer material will tend to muffle or dampen tone more effectively; the closer to the bridge, the more volume is reduced; and the tighter the mute is adjusted the more it will tend to effect sustain. Although all these sound characteristics are somewhat subjective, the purpose of noting these general characteristics is to demonstrate the broad range of application for the mute in question

The current banjo mute and damper furthermore provides the damping effect that many players desire with more versatility and better aesthetics than the customary towel or rag employed to dampen tone and control overtones. Often overtones create an undesirable brashness in banjos, and players often find added warmth and sweetness of tone is achieved by applying some soft material such as a bundled towel or cloth to the underside of the banjo head, thus effecting note sustain. The mute and damper in question was specifically designed to replicate and replace the ad-hoc objects employed for this effect with a versatile and aesthetically pleasing device.

### BRIEF DESCRIPTION OF THE DRAWINGS

FIG. 1 shows an exploded transparent view of the four essential components of the design, with no threading present on the female post of the upper component (3) or the male post of the lower component (4).

FIG. 2 shows transparent and non-transparent views of the upper component and the lower component assemblies, as well as an up-spiraling arrow on the female post of the non-transparent upper component to demonstrate screw-action adjustment if threading is present.

FIG. 3 shows a transparent view of the device fully assembled in its collapsed, most compact, state.

FIG. 4 shows a cutaway view of the interior of a generic banjo to demonstrate placement of the banjo mute and damper between the banjo's dowel stick and the underside of the head, with vertical arrows indicating the direction of height adjustability and horizontal arrows representing placement adjustability.

FIG. 5 shows a generic banjo in profile for reference.

FIG. 6 shows a generic banjo in front view for reference.

FIG. 7 shows a generic banjo in back view for reference.

### DETAILED DESCRIPTION OF THE DRAWINGS

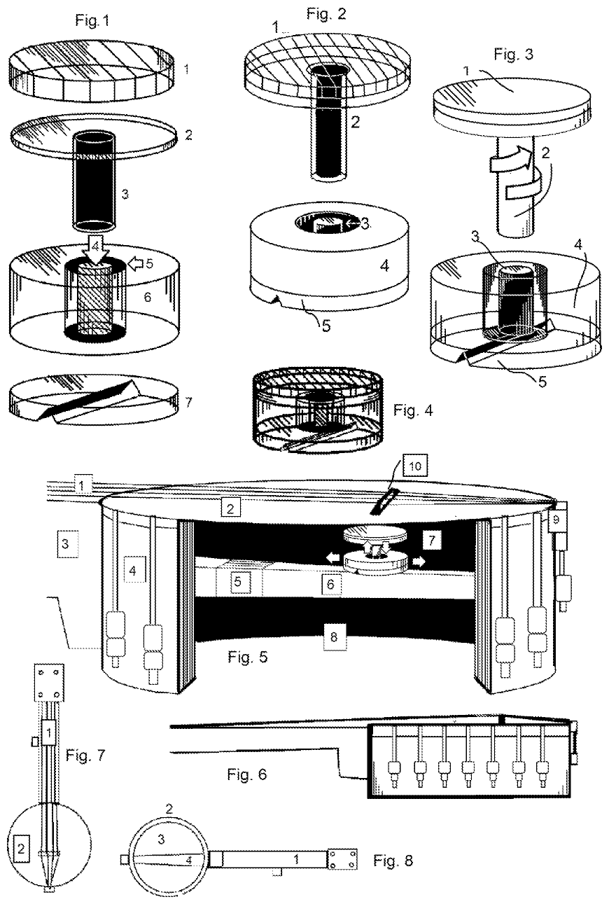

FIG. 1 shows an exploded transparent view of the banjo mute and damper, with its key individual components separated roughly as they would be prior to the final device being assembled for use.

(FIG. 1.1) shows the disc-shaped damping surface which contacts the underside of the banjo head to produce the muting or damping effect desired. Different materials (such as leather, wood, metal, fur, etc.) have different effects on the device's muting and damping properties, yet share the same basic shape and function of contacting the underside of the banjo head to limit vibrations of said head.

(FIG. 1.2) shows the flat disc-shaped platform onto which the damping material (1.1) is mounted. This flat platform is connected to (1.3) which is a hollow post which houses the adjustability mechanism of its lower mating component (1.4) and recesses into the hollow center (1.5) of the lower component (1.6) so as to collapse entirely, leaving little or no space between the upper platform (1.2) and the upper surface of the lower component (1.6) when fully assembled and adjusted to its minimum height.

This hollow female post (1.3) may be internally threaded to accept a male screw if its lower mating component (1.4) is adjusted by threaded screw, or may be unthreaded in the case of component (1.4) being a spring.

(1.7) is a protective base platform that is attached on the underside of (1.6), designed to contact the banjo's dowel stick or coordinator rod. (1.7) is notched along its length to mate securely to a banjo's round coordinator rod or to sit flat upon its square dowel stick. It may be made of wood or leather, or any material that will prevent damage to the banjo's coordinator rod and dowel stick and give it a secure base so it doesn't slide off when the device is expanded and pressure is applied by the expanded components.

(FIG. 2) shows individually assembled, alternating transparent and non-transparent versions of the Upper Component and Lower Component. (2.1) shows the damping surface mounted to (2.2), which includes the connected platform and hollow post of (FIG. 1.2). (2.3) shows the mating component which joins inside the hollow post of (2.2). (2.3) is housed within a hole in the center of the base component (2.4). (2.5) is joined to the base of (2.4) to act as a protective base which contacts the banjo's dowel stick or coordinator rod. (2.3), (2.4), and (2.5) are all non-transparent in this figure.

(FIG. 3) shows a non-transparent view of the upper component, with (3.1) being the damping surface, as mounted to the platform and hollow post of (3.2). An upward-spiraling arrow is shown wrapped around the hollow post of (3.2) to represent the mode of height adjustment should the hollow post be internally threaded, with screw-action as the mode of adjustment.

The lower component is shown in transparent view, with (3.3) being the male adjustment mechanism, housed in the hollow center of the base component (3.4), which is mounted on the notched, disc-shaped (3.5) to protect the banjo's coordinator rod or dowel stick.

(FIG. 4) shows a transparent view of the completely assembled and fully collapsed banjo mute and damper. The upper and lower components are sitting flush and collapsed into one another, and the hollow post is mated to its lower male component. Thus the flat platform of the upper component rests upon the topmost surface of the lower component, and the male element of the lower component is housed within the hollow post of the upper component, and the hollow post is furthermore housed inside the hollow center of the lower component.

(FIG. 5) shows the mode of application of the banjo mute and damper as applied to a banjo. A generic banjo is seen at slightly angled side-view, with a cutaway section showing the interior (5.8) of the pot or drum-body (5.4) of the banjo. A dowel stick (5.6) runs through the pot of the banjo, connecting the neck (5.3) to the tailpiece area (5.9). The strings of the banjo (5.1) pass from the tailpiece area (5.9) up to tuners at the headstock area, passing across a bridge and causing the banjo head (5.2) to resonate and amplify their vibrations. (5.7) shows the assembled banjo mute and damper placed under the bridge, where it would have most significant effect on volume. The banjo mute and damper (5.7) is shown with arrows indicating the vertical and lateral modes of adjustment, which can change its effect on tone and volume. Vertical adjustment in height allows for varied tension upon the underside of the banjo head (5.2) as well as varied application along the length of the dowel stick or coordinator rod of the banjo (5.6). (5.5) indicates an area along the length of the dowel stick (5.6) which is a common area of application for improved tone.

(FIG. 6) shows a generic side view of a banjo, minus the headstock and tuners, similar to (FIG. 5) without the cutaway section and not show at a slight angle.

(FIG. 7) Shows a generic front view of a banjo for reference, with (7.1) being the general area of the neck assembly (neck, fingerboard, frets, tuners, nut, etc) and (7.2) showing the pot assembly area (pot, hardware, banjo head, bridge, tailpiece, etc.)

(FIG. 8) shows a generic back view of a banjo for reference, with (8.1) being the backside of the neck assembly, (8.2) being the banjo rim or pot, (8.3) being the underside of the banjo head, and (8.4) being the banjo's dowel stick, on which the banjo mute and damper rests.

1. A banjo mute and damper comprising:
a two-piece height-adjustable apparatus with flat upper platform whose first piece contacts the underside of a banjo head, and whose second piece rests for support on a banjo's dowel stick or coordinator rod, and by contacting the underside of said banjo head changes the volume or tone of said banjo, and whose mechanism of adjustment is a hollow post supporting said platform which recesses into an opening of a second lower component which rests on said coordinator rod or dowel stick, the recess in which houses a male adjustment mechanism which mates with said hollow post, and which second lower component acts as a base or support for the adjustment of said upper post and platform.

2. The banjo mute and damper as in claim 1, further comprising a base with a hole or opening in its center substantial enough to house said hollow post; and

3. The banjo mute and damper as in claim 2, further comprising a screw or spring seated within the hole or opening in the center of the base of claim 2; and

4. The banjo mute and damper as in claim 3 further comprising a hollow post as in claim 1 which nests within said opening in wooden base as in claim 2, wherein said hollow post mates with or houses said spring or screw of claim 3; and wherein said hollow post adjusts upward and protrudes out of said wooden base as in claim 2; and

5. The banjo mute and damper as in claim 4, further comprising a flat platform supported by said hollow post as in claim 3 which contacts the underside of a banjo head so as to effect vibrations in said banjo head as in claim 1; wherein said flat platform supports soft damping material such as leather or foam, or harder damping material such as brass or wood; and

6. The banjo mute and damper as in claim 5, further comprising a protective layer of flat material beneath said wooden base as in claim 2 which may insolate it from contacting and damaging the banjo's dowel stick or coordinator rod; and wherein said protective layer may be notched to secure it by means of pressure to said coordinator rod; and wherein said protective layer may support said screw or spring as in claim 3;

7. A banjo mute or damper as in claim 1; wherein said apparatus may be applied for benefit of tonal and volume changes in other stringed musical instruments which may accommodate its design and basic construction, by applying pressure at various proximities to the bridge on the underside of the resonating surface of said musical instruments, and which would then rest for support on the closest corresponding surface of said musical instruments, such as the wooden back or brace of a guitar.
